(19) United States
(12) Patent Application Publication
(10) Pub. No.: US 2023/0037452 A1
(43) Pub. Date: Feb. 9, 2023

(54) APPARATUS FOR DETECTING SURFACE CONDITION OF OBJECT AND METHOD FOR MANUFACTURING APPARATUS

(71) Applicant: ABB Schweiz AG, Baden (CH)

(72) Inventors: Jihuan Tian, Shanghai (CN); Jiafan Zhang, Shanghai (CN); Qi Lu, Shanghai (CN)

(21) Appl. No.: 17/759,035

(22) PCT Filed: Feb. 12, 2020
(86) PCT No.: PCT/CN2020/074929

§ 371 Date: Jul. 18, 2022

(51) Int. Cl. G01N 21/88; G01N 21/956

(52) U.S. Cl. CPC G01N 21/8803; G01N 21/956; G01N 21/8806; G01N 2021/8819

(57) ABSTRACT

An apparatus for detecting a surface condition of an object. The apparatus comprises a light source, a reflective face and an imaging device. The imaging device is configured to receive reflected light emanating from the reflective face. The reflective face is oriented at a first acute angle relative to an optical axis of the imaging device, such that a projection area of a virtual image of a surface formed via the reflective face is greater than a projection area of the surface on a plane perpendicular to the optical axis.

### FIELD

Example embodiments of the present disclosure generally relate to improvement of the product quality inspection, and more particularly, to an apparatus for detecting a surface of an object and a method for manufacturing the apparatus.

### BACKGROUND

Machine vision is an important and effective sensing technology for product quality inspection, which has been widely adopted in modern automation and manufacture industry. For a thorough examination of the inner or outer surface surrounding the product to be inspected, a photo recording the surface information is essential for further processing procedures. The object to be detected may usually be a revolution body with a 360-degree circumferential surface. How to conveniently capture a full image of the circumferential surface becomes a challenge for designers.

Conventionally, there are provided a plurality of methods to capture an image of the object surface to be detected. For example, a number of static cameras may be provided around the circumferential surface of the object. However, this method greatly increases the cost and the stitching among the multiple pictures captured by the multiple static cameras and is also troublesome. Alternatively, to solve the above problems, a single camera may be arranged on the moving robot, which rotates relative to the surface to get the image of the surface of interest. Yet, the rotation of the robot wastes cycle time, which greatly reduces the detection efficiency.

A wide-angle or fisheye lens may also be considered. However, the detecting angle of such lens is limited, for example, less than 250 degrees, which makes the lens still unable to get the full information of the 360-degree surface of the object, especially in the situation where the surface of interest is the outer surface of the revolution body.

In WO2017031710A1, a solution is proposed for inspection of the object from different perspectives via a single image frame with the help of reflection devices. However, multiple reflection devices are required, which means high cost and complexity.

Therefore, there is a need for a simpler and cheaper design to enable the surface condition to be detected.

### SUMMARY

Example embodiments of the present disclosure propose a solution for capturing a full image of a surface of an object in a convenient and cheap way.

In a first aspect, embodiments of the present disclosure relate to an apparatus for detecting a surface condition of an object, comprising: a light source configured to illuminate a surface of the object; a reflective face arranged towards the surface of the object and to reflect light emanating from the surface; and an imaging device configured to receive the reflected light from the reflective face; wherein the reflective face is oriented at a first acute angle relative to an optical axis of the imaging device, such that a projection area of the virtual image of the surface formed via the reflective face is greater than a projection area of the surface on a plane perpendicular to the optical axis.

According to embodiments of the present disclosure, the image of the surface can be reflected by the reflective face and be captured by the image device. As the projection area of the virtual image is greater than the surface, more information can be captured and thus the quality inspection can be facilitated.

In some embodiments, the apparatus further comprises a reflective member comprising the reflective face and a second face, a second acute angle is formed between the second face and the reflective face, and the second face is perpendicular to the optical axis.

In some embodiments, the reflective member is of a cone frustum shape, and wherein the reflective face is a side surface of the reflective member and the second face is a bottom surface of the reflective member.

In some embodiments, the surface of the object is provided further away from the optical axis than the reflective face, and a reflective material is provided on an outer side of the reflective face away from the optical axis.

In some embodiments, the surface of the object is provided closer to the optical axis than the reflective face, and a reflective material is provided on an inner side of the reflective face towards the optical axis.

In some embodiments, the object is a cover of a semi-spherical shape, and wherein a central axis of the cover is parallel to the optical axis and a height of the surface along the optical axis is no greater than a height of the reflective face along the optical axis.

In some embodiments, the object is of a prism shape, wherein a side edge of the object is parallel to the optical axis and the surface is provided on a side surface of the object.

In some embodiments, the object is of a cylindrical shape, wherein a central axis of the object is parallel to the optical axis and the surface is provided on a side surface of the object.

In some embodiments, the first acute angle is in a range from 30 to 60 degrees.

In some embodiments, the second acute angle is about 45 degree.

In some embodiments, the reflective face is provided with a reflective material comprising a foil made of aluminum, or the reflective face is coated with a coating made of aluminum.

In some embodiments, the apparatus further comprises a processing unit coupled to the imaging device and configured to: receive a photo of the virtual image captured by the imaging device; and process the photo to determine whether there is a defect on the surface.

In a second aspect, embodiments of the present disclosure relate to a method for manufacturing an apparatus for detecting a surface condition of an object, comprising: providing a light source configured to illuminate a surface of the object; providing a reflective face arranged towards the surface of the object and to reflect light from the surface; and providing an imaging device configured to receive the reflected light emanating from the reflective face; wherein providing the reflective face comprises orienting the reflective face at a first acute angle relative to an optical axis of the imaging device, such that a projection area of a virtual image of the surface formed via the reflective face is greater than a projection area of the surface on a plane perpendicular to the optical axis.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 illustrates a cross-sectional view of an apparatus for detecting a surface condition of an object in accordance with an example embodiment of the present disclosure;

FIG. 2 illustrates a perspective view of a portion of the apparatus of FIG. 1, showing an exemplary spatial relation between the object and the reflective face;

FIG. 3 illustrates a cross-sectional view of an apparatus for detecting a surface condition of an object in accordance with another example embodiment of the present disclosure;

FIG. 4 illustrates a perspective view of a portion of the apparatus of FIG. 3, showing an exemplary spatial relation between the object and the reflective face;

FIGS. 5-6 illustrate exemplary objects that can be used with the apparatus according to an example embodiment of the present disclosure; and

FIG. 7 illustrates a method 700 for manufacturing an apparatus for detecting a surface condition of an object in accordance with some example embodiments of the present disclosure.

Throughout the drawings, the same or corresponding reference symbols refer to the same or corresponding parts.

### DETAILED DESCRIPTION

The subject matter described herein will now be discussed with reference to several example embodiments. These embodiments are discussed only for the purpose of enabling those skilled persons in the art to better understand and thus implement the subject matter described herein, rather than suggesting any limitations on the scope of the subject matter.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.”

Unless specified or limited otherwise, the terms “mounted,” “connected,” “supported,” and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar or corresponding parts in the figures. Other definitions, explicit and implicit, may be included below.

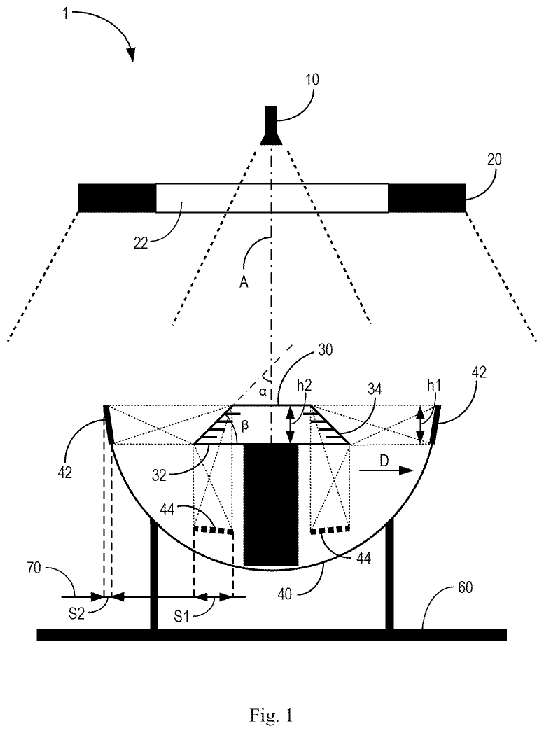

Embodiments of the present invention will be described in detail with reference to FIGS. 1-4 hereinafter.

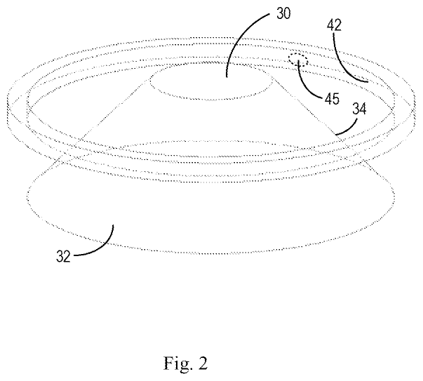

FIG. 1 illustrates a cross-sectional view of an apparatus 1 for detecting a surface condition of an object 40 in accordance with an example embodiment of the present disclosure. FIG. 2 illustrates a perspective view of a portion of the apparatus of FIG. 1.

As shown, the apparatus 1 generally comprises a light source 20, a reflective face 34 and an imaging device 10. The light source 20 is configured to illuminate a surface 42 of the object 40. The surface 42 of the object 40 is the surface whose condition is to be detected. The reflective face 34 is arranged towards the surface 42 of the object 40 and thus can reflect light from the surface 42. The imaging device 10 defines an optical axis A. As shown in the figures, the imaging device 10 is configured to receive the reflected light from the reflective face 34.

The virtual image 44 of the surface is formed by means of the reflection of the reflective face 34 and thus can be captured by the imaging device 10. The virtual image 44 of the surface 42 has a projection area S1 on a plane 70 perpendicular to the optical axis A. The surface 42 itself has a projection area S2 on that plane 70. As illustrated, the reflective face 34 is at a first acute angle α relative to the optical axis A. Due to such an arrangement, the projection area S1 of the virtual image 44 is greater than the projection area S2 of the surface 42.

As illustrated in FIG. 1, since the surface 42 is in a small angle with the optical axis A or is even substantially parallel to the optical axis A, the projection area S2 of the surface 42 on the plane 70 is quite small, which makes the effective area captured by the imaging device 10 very limited. Thus, no enough information regarding the surface 42 could be obtained. This would not be ideal for further processing. With the reflective face 34 as shown, the virtual image 44 has a greater projection area S1 than the projection area S2.

Therefore, more information from the virtual image 44 can be obtained by the imaging device 10. In this way, the information indicated by the surface 42 can be obtained in a simple manner.

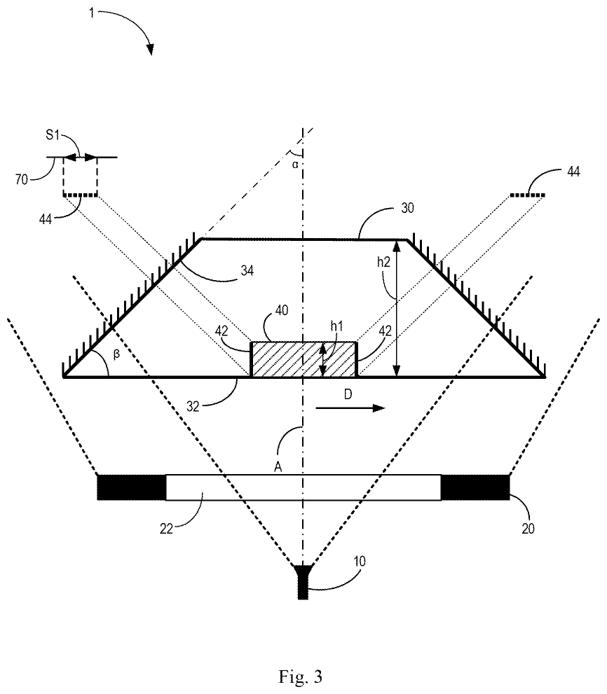

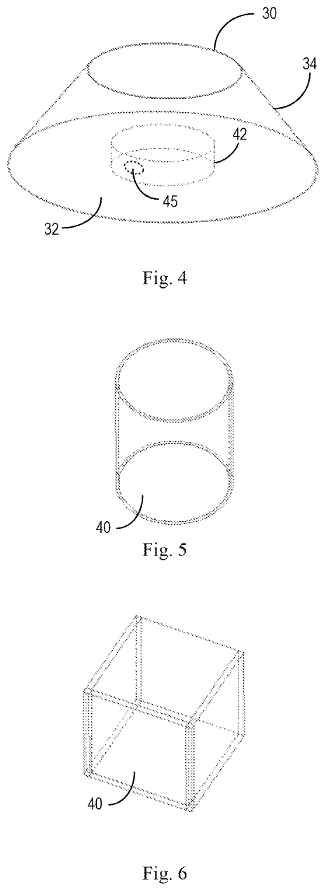

FIG. 3 illustrates a cross-sectional view of an apparatus for detecting a surface condition of an object in accordance with another example embodiment of the present disclosure. FIG. 4 illustrates a perspective view of a portion of the apparatus of FIG. 3.

In some embodiments, as illustrated in FIGS. 1 and 3, the apparatus 1 may further comprise a reflective member 30. The reflective member 30 comprises the reflective face 34 and a second face 32. The second face 32 is located parallel with the plane 70 and thus perpendicular to the optical axis A. The second face 32 is oriented with a second acute angle β relative to the reflective face 34.

As illustrated in FIGS. 2 and 4, in some embodiments, the reflective member 30 is of a cone frustum shape. The bottom surface of the cone frustum is the second face 32 which lies perpendicular to the optical axis A. The reflective face 34 is the side surface of the cone frustum forming a cone angle β with the bottom surface.

In this way, with a cone frustum which can be easily manufactured, the surface condition of the object 40 can be detected conveniently.

Although FIGS. 1-4 illustrate that the reflective member 30 is in a form of a cone frustum shape, it is to be understood that, this is merely example without suggesting any limitation as to the scope of the present disclosure. In an alternative embodiment, a complete cone with an apex may also be possible, as long as the height of the reflective member 30 ensures that the whole area of interest can be reflected and then be captured by the imaging device 10.

In some embodiments, as illustrated in FIGS. 1 and 2, the surface 42 of the object 40 may be provided further away from the optical axis A than the reflective face 34. A reflective material is provided on the outer side of the reflective face 34. In this way, the condition of the inner face of the object 40 can be detected.

In some embodiments, as illustrated in FIGS. 3 and 4, the surface 42 of the object 40 may be provided closer to the optical axis A than the reflective face 34. A reflective material may be provided on the inner side of the reflective face 34 towards the optical axis A. In this way, the condition of the outer face of the object 40 can be detected.

In this way, the complete information of both the inner and outer faces 42 of the object 40 may be captured in one shot with a cheap and simple way.

In some embodiments, as illustrated in FIGS. 1 and 3, the object 40 may be a cover of a semi-spherical shape. As illustrated, a central axis of the cover is parallel to the optical axis A. The surface 42 has a height h1 along the optical axis A and the reflective face 34 has a height h2 along the optical axis A. With reference to FIG. 1, in some embodiments, the height h1 of the surface 42 may equal to the height h2 of the reflective face 34. In other embodiment, with reference to FIG. 3, the height h1 of the surface 42 may be less than the height h2 of the reflective face 34. In this way, no information related to the surface condition of the object 40 would be missing.

In some embodiments, the cover may be of a dome shape. In some embodiments, the cover may be used for security cameras in the field of security.

In some embodiments, the light source 20 may be in a form of a point light source or a surface light source. In some embodiments, as illustrated in FIGS. 1 and 3, the light source 20 may be in a form of an annular light source. An opening 22 is provided with the annular light source to allow the optical path to pass through. It is to be understood that this illustrated configuration is merely an example without suggesting any limitation as to the scope of the present disclosure. The light source 20 may be shaped in a different way as long as the light source 20 can effectively illuminate the inspection area and would not affect the optical path for the imaging device 10.

FIGS. 5-6 illustrate exemplary objects 40 that can be used with the apparatus 1 according to an example embodiment of the present disclosure.

In some embodiments, as illustrated in FIG. 5, the object 40 may be of a prism shape. As illustrated, the side edge of the object 40 may be parallel to the optical axis A and the surface 42 is provided on a side surface of the object 40. Although FIG. 5 illustrates a quadrangular prism, it is to be understood that this is merely an example without suggesting any limitation as to the scope of the present disclosure. A prism with any other number of edges may also be possible, for example, a triangular prism, a pentagonal prism, etc., which may depend on the demand of the user. Moreover, Although FIG. 5 illustrates a right prism, it is to be understood that in some embodiments, the object 40 may be an oblique, bent or twisted prism.

In some embodiments, as illustrated in FIG. 6, wherein the object 40 may be of a cylindrical shape. As illustrated, a central axis of the object 40 may be parallel to the optical axis A and the surface 42 is provided on a side surface of the object 40. Although FIG. 6 illustrates a circular prism, it is to be understood that this is merely example without suggesting any limitation as to the scope of the present disclosure. In some embodiments, the object 40 may be an oval prism. In other embodiments, the object 40 may be of a tubular shape. In this way, the apparatus 1 in according to the present disclosure is adapted to detect the object 40 of a variety of shapes.

In some embodiments, the angle α between the side surface and the bottom surface may be in a range from 30 to 60 degrees.

In some embodiments, the angle β may be approximately 45 degrees. In this way, when the surface 42 of the object 40 is parallel to the optical axis A, the virtual image 44 formed by the reflective face 34 would be normal to the optical axis A. Thus, the first projection area S1 would be kept to be the maximum and the imaging device 10 is able to capture adequate information for processing. In this way, the operation is simple and more time efficient.

It is to be understood that the value listed herein is only illustrative, rather than restrictive. In some embodiments, the side surface may be oriented relative to the bottom surface by the cone angle β of other values, as long as the first projection area S1 of the virtual image 44 on the plane 70 is greater than the second projection area S2 of the surface 42 of the object 40.

In some embodiments, the reflective face 34 may be provided with a reflective material such as an aluminum foil. In other embodiments, the reflective face 34 may be coated with a coating made of aluminum. In this way, with a cheap reflective material attached to the reflective face 34, the accuracy of the quality inspection may be guaranteed without significantly changing the existing structure of the image capturing unit.

It is to be understood that the material of the reflective face 34 may be any material already known or to be developed in the future, e.g. a metal film, as long as the material may provide sufficient reflective property to form the virtual image 44.

In this way, with a low-cost reflective material provided on the surface of a cone frustum reflective member 30, a full image with a 360-degree view of the inner or outer face can be detected by a single shot. Moreover, the cost can be controlled in an acceptable level, which greatly expands the scope of use.

In some embodiments, the apparatus 1 may further comprise a processing unit coupled to the imaging device 10. The processing unit is configured to receive an image of the virtual image 44 captured by the imaging device 10. Moreover, the processing unit is further configured to process the image to determine whether there is a defect 45 on the surface 42. In this way, the efficiency of the quality inspection may be improved.

In some embodiments, the processing unit may be integrated with the imaging device 10. In some embodiments, the processing unit may be remotely coupled to the imaging device 10. Scope of the present disclosure is not limited to any specific manners of connection.

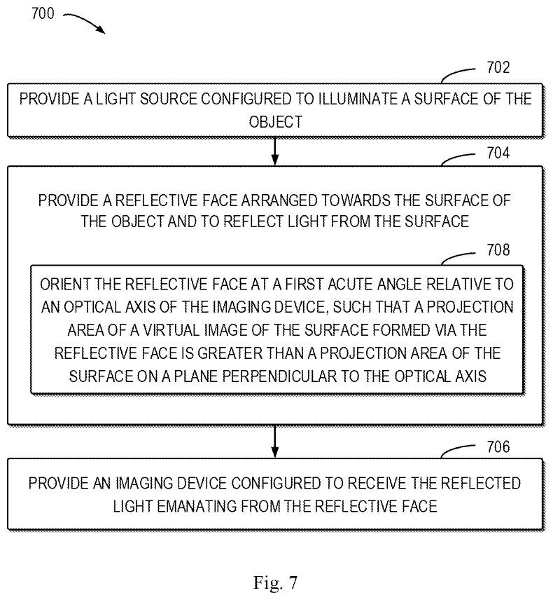

FIG. 7 illustrates a method 700 for manufacturing an apparatus for detecting a surface condition of an object in accordance with some example embodiments of the present disclosure.

At block 702, a light source 20 configured to illuminate a surface 42 of the object 40 is provided. At block 704, a reflective face 34 arranged towards the surface 42 of the object 40 and to reflect light from the surface 42 is provided. At block 706, an imaging device 10 configured to receive the reflected light from the reflective face 34 is provided.

At block 708, providing the reflective face 34 comprises orienting the reflective face 34 at a first acute angle α relative to an optical axis A of the imaging device 10, such that a projection area S1 of an virtual image 44 of the surface 42 formed via the reflective face 34 is greater than a projection area S2 of the surface 42 on a plane 70 perpendicular to the optical axis A.

In some embodiments, referring back to FIGS. 1 and 3, the method 700 may further comprise providing a reflective member 30. The reflective member 30 comprises the reflective face 34 and a second face 32.

With reference to FIGS. 2 and 4, in some embodiments, the reflective member 30 is of a cone frustum shape. The bottom surface of the cone frustum is the second face 32 which lies perpendicular to the optical axis A. The reflective face 34 is the side surface of the cone frustum forming a cone angle β with the bottom surface.

In some embodiments, the method 700 may further comprise providing the surface 42 of the object 40 to be further away from the optical axis A than the reflective face 34. A reflective material may be provided on the outer side of the reflective face 34.

In some embodiments, the method 700 may further comprise providing the surface 42 of the object 40 to be closer to the optical axis A than the reflective face 34. A reflective material may be provided on the inner side of the reflective face 34 towards the optical axis A.

In some embodiments, the method 700 further comprises providing a processing unit coupled to the imaging device 10. The processing unit is configured to receive an image of the virtual image 44 captured by the imaging device 10. Moreover, the processing unit is further configured to process the image to determine whether there is a defect 45 on the surface 42.

It is to be understood that the apparatus, the structure or the process involved in FIG. 7 have been described above with reference to FIGS. 1-6, and the details will not be described hereinafter for the sake of brevity.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Compared with the conventional approaches to detect the surface condition of an object, by simply providing a single reflective face 34 in accordance with exemplary embodiments described above, the full information of the surface condition can be captured in one shot. Thus, the detecting efficiency can be greatly increased and the cost can be reduced.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus for detecting a surface condition of an object, comprising:
a light source configured to illuminate a surface of the object;
a reflective face arranged towards the surface of the object and to reflect light from the surface; and
an imaging device configured to receive the reflected light emanating from the reflective face;
wherein the reflective face is oriented at a first acute angle relative to an optical axis of the imaging device, such that a projection area of a virtual image of the surface formed via the reflective face is greater than a projection area of the surface on a plane perpendicular to the optical axis.

2. The apparatus of claim 1, further comprising:
a reflective member comprising the reflective face and a second face, a second acute angle is formed between the second face and the reflective face, and the second face is perpendicular to the optical axis.

3. The apparatus of claim 2, wherein the reflective member is of a cone frustum shape, the reflective face is a side surface of the reflective member, and the second face is a bottom surface of the reflective member.

4. The apparatus of claim 1, wherein the surface of the object is provided further away from the optical axis than the reflective face and a reflective material is provided on an outer side of the reflective face away from the optical axis.

5. The apparatus of claim 1, wherein the surface of the object is provided closer to the optical axis than the reflective face, and a reflective material is provided on an inner side of the reflective face towards the optical axis.

6. The apparatus of claim 4, wherein the object is a cover of a semi-spherical shape, and wherein a central axis of the cover is parallel to the optical axis and a height of the surface along the optical axis is no greater than a height of the reflective face along the optical axis.

7. The apparatus of claim 4, wherein the object is of a prism shape, wherein a side edge of the object is parallel to the optical axis and the surface is provided on a side surface of the object.

8. The apparatus of claim 4, wherein the object is of a cylindrical shape, wherein a central axis of the object is parallel to the optical axis and the surface is provided on a side surface of the object.

9. The apparatus of claim 2, wherein the first acute angle is in a range from 30 to 60 degrees.

10. The apparatus of claim 3, wherein the second acute angle is about 45 degrees.

11. The apparatus of claim 1, wherein the reflective face is provided with a reflective material comprising a foil made of aluminum, or the reflective face is coated with a coating made of aluminum.

12. The apparatus 44 of claim 1, further comprising:
a processing unit coupled to the imaging device and configured to:
receive a photo of the virtual image captured by the imaging device; and
process the photo to determine whether there is a defect on the surface.

13. A method for manufacturing an apparatus for detecting a surface condition of an object, comprising:
providing a light source configured to illuminate a surface of the object;
providing a reflective face arranged towards the surface of the object and to reflect light from the surface; and
providing an imaging device configured to receive the reflected light emanating from the reflective face;
wherein providing the reflective face comprises orienting the reflective face at a first acute angle relative to an optical axis of the imaging device, such that a projection area of a virtual image of the surface formed via the reflective face is greater than a projection area of the surface on a plane perpendicular to the optical axis.

14. The apparatus of claim 5, wherein the object is a cover of a semi-spherical shape, and wherein a central axis of the cover is parallel to the optical axis and a height of the surface along the optical axis is no greater than a height of the reflective face along the optical axis.

15. The apparatus of claim 5, wherein the object is of a prism shape, wherein a side edge of the object is parallel to the optical axis and the surface is provided on a side surface of the object.

16. The apparatus of claim 5, wherein the object is of a cylindrical shape, wherein a central axis of the object is parallel to the optical axis and the surface is provided on a side surface of the object.
